(19) United States
(12) Patent Application Publication
(10) Pub. No.: US 2016/0199745 A1
(43) Pub. Date: Jul. 14, 2016

(54) Stuffed Toy For Use With a Child Car Seat

(71) Applicants: Jaclyn Powell, Lodi, CA (US); Justin Powell, Lodi, CA (US)

(72) Inventors: Jaclyn Powell, Lodi, CA (US); Justin Powell, Lodi, CA (US)

(21) Appl. No.: 14/592,466

(22) Filed: Jan. 8, 2015

(51) Int. Cl. A63H 3/00; B60N 2/48; A47C 7/38; A63H 3/02; A63H 3/46

(52) U.S. Cl. CPC A63H 3/005; A63H 3/02; A63H 3/46; A47C 7/383; B60N 2/4879

(57) ABSTRACT

A stuffed toy for use with a child car seat positioned in an automobile includes a body portion containing a padded material. The stuffed toy includes a first appendage coupled to and extending away from an exterior surface of the body portion. A second appendage is spaced apart from the first appendage and also coupled to and extending away from the body portion. A first fastener is coupled to the first appendage that is movable between a secured configuration tightly adjacent the first appendage and a released configuration displaced therefrom. The first fastener is configured to selectively receive the shoulder safety belt and is coupled thereto when the first fastener is in the secured configuration so as to position the body portion frontwardly adjacent the child car seat. A second fastener is coupled to the second appendage and operable in the same manner as the first fastener.

### BACKGROUND OF THE INVENTION

This invention relates generally to child car seat accessories and, more particularly, to a stuffed toy that is selectively coupled to a shoulder seat belt of a vehicle or to the safety belts of an over-the-head child car seat so as to be positioned frontwardly adjacent a child and is useful 1) as a pillow, 2) as a holder for a blanket, snacks, or toys, and 3) as a backpack when released from the shoulder or safety belt.

Every parent or caregiver that has transported an infant or toddler in an upright car seat positioned atop a vehicle seat has witnessed the obvious discomfort of the toddler's head hanging uncomfortably to the side or forward when the child falls asleep. The parent may try to prop a pillow, jacket, or another soft object beside the child's head to prevent the apparent discomfort, such efforts are rarely successful. In addition, most parents have also experienced the difficulty of maintaining baby supplies, blankets, toys, snacks, and the like near the car seat and child while traveling. Invariably, a baby bag is stored on the floorboard of the car, behind the seat, or some other location displaced from where it ultimately becomes needed.

Therefore, it would be desirable to have a stuffed toy, such as a teddy bear, that receives and may be coupled to a shoulder belt in a vehicle or to the safety belts of a car seat itself and to be configured and positioned to serve as a pillow to a toddler's head if he falls asleep while in his car seat. Further, it would be desirable to have a stuffed toy having compartments configured to store a blanket, snacks, and other objects. In addition, it would be desirable to have a stuffed toy with optional shoulder straps for use as a backpack when not coupled to a shoulder seat belt and having a hand warming pocket to warm the hands of the child.

### SUMMARY OF THE INVENTION

A stuffed toy according to the present invention for use with a child car seat positioned in an automobile having a shoulder seat belt includes a body portion containing a padded material. The stuffed toy includes a first appendage coupled to and extending away from an exterior surface of the body portion. A second appendage is spaced apart from the first appendage and also coupled to and extending away from the body portion. A first fastener is coupled to the first appendage that is movable between a secured configuration tightly adjacent the first appendage and a released configuration displaced therefrom. The first fastener is configured to selectively receive the shoulder seat belt and is coupled thereto when the first fastener is in the secured configuration so as to position the body portion frontwardly adjacent the child car seat. A second fastener is coupled to the second appendage and operable in the same manner as the first fastener.

Therefore, a general object of this invention is to provide a stuffed toy for use with a child car seat that couples to a vehicle's shoulder seat belt strap so as to position the stuffed toy forwardly adjacent a child seated in the car seat.

Another object of this invention is to provide a stuffed toy, as aforesaid, that has facial features and appendages indicative of a stuffed animal and is configured to simulate hugging the child seated in the car seat.

Still another object of this invention is to provide a stuffed toy, as aforesaid, having a body portion that defines a first chamber and having a blanket selectively stored in and removable from the first chamber.

Yet another object of this invention is to provide a stuffed toy, as aforesaid, having a main chamber separate from the first chamber and configured to store other articles.

A further object of this invention is to provide a stuffed toy, as aforesaid, having a pair of removable straps configured to selectively transform the stuffed toy into a backpack.

A still further object of this invention is to provide a stuffed toy that is adapted to receive and be coupled to the overhead safety straps of a car seat so as to be positioned frontwardly adjacent a child seated in the car seat.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a front perspective view of a stuffed toy according to a preferred embodiment in use with a child car seat positioned on a vehicle seat and in use with a vehicle shoulder belt;

FIG. 2a is a rear perspective view of the stuffed toy as in FIG. 1;

FIG. 2b is an isolated view on an enlarged scale taken from FIG. 2a illustrated with a first fastener in a secured configuration;

FIG. 2c is an isolated view on an enlarged scale taken from FIG. 2a illustrated with a first fastener in a released configuration;

FIG. 3 is a front perspective view of the stuff toy illustrated with a main chamber cover in an open configuration;

FIG. 4a is a rear perspective view of the stuffed toy with a first chamber cover in an extended configuration;

FIG. 4b is a rear perspective view of the stuffed toy with the first chamber cover in a retracted configuration and a blanket removed from the first chamber;

FIG. 5a is a front view of the stuffed toy as in FIG. 3;

FIG. 5b is a sectional view taken along line 5b-5b of FIG. 5a;

FIG. 6 is a front perspective view of the stuffed toy as in FIG. 3 illustrated with a pair of backpack straps coupled thereto;

FIG. 7a is a perspective view of the stuffed animal in use with a child car seat having over-the-head straps;

FIG. 7b is an isolated view on an enlarged scale taken from a portion of FIG. 7a with the first fastener in a secured configuration; and

FIG. 7c is another isolated view on an enlarged scale taken from a portion of FIG. 7a with the first fastener in a released configuration.

### DESCRIPTION OF THE PREFERRED EMBODIMENT

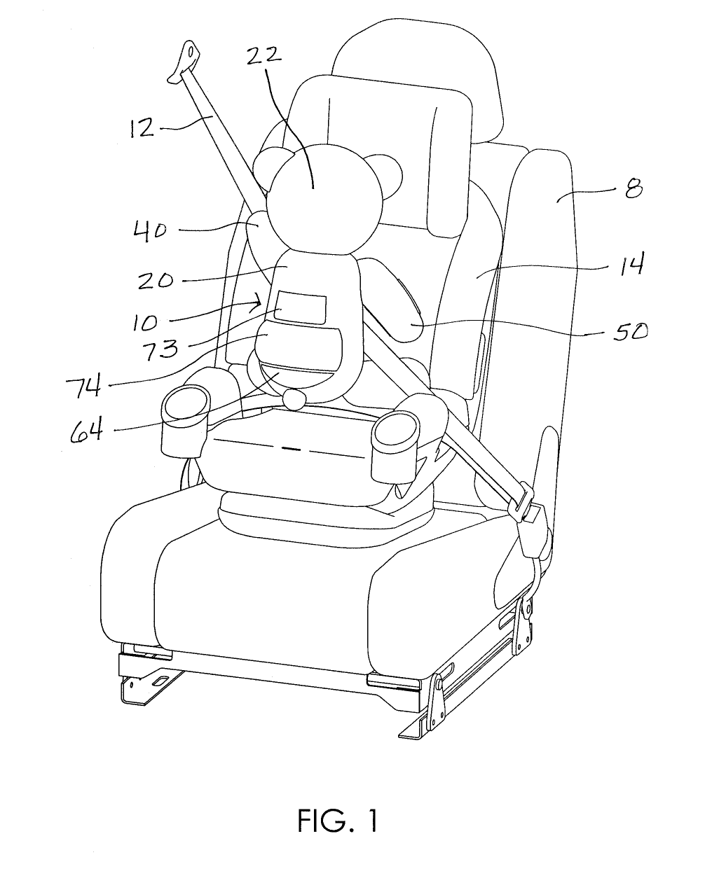

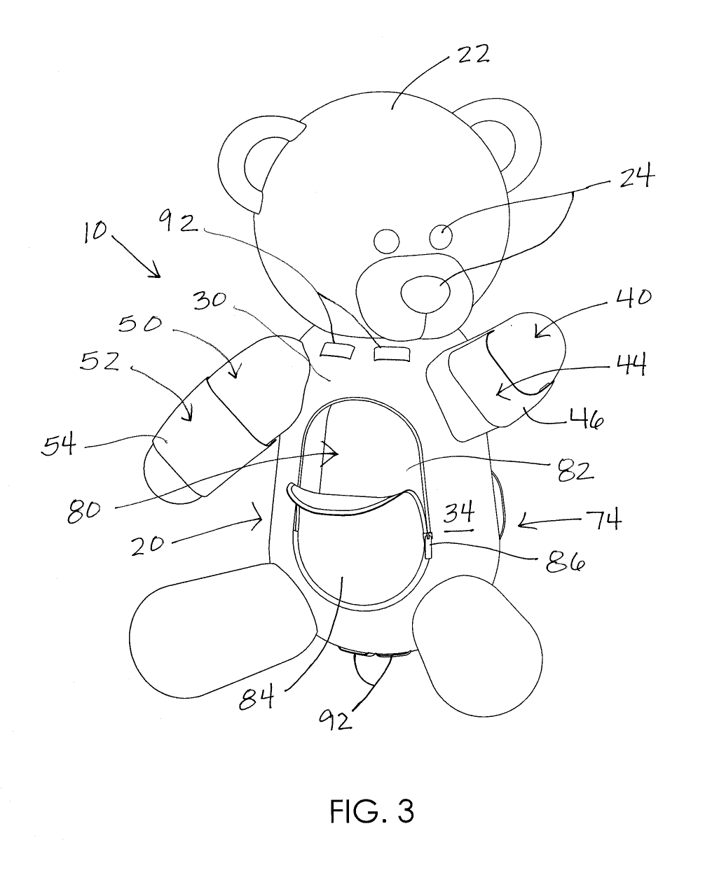

A stuffed toy for use with a child car seat positioned on a vehicle seat and a vehicle shoulder belt according to a preferred embodiment of the present invention will now be described with reference to FIGS. 1 to 7c of the accompanying drawings. The stuffed toy 10 includes a body portion 20, a hand warming pocket 74, a first chamber 60 for holding a blanket 68, a main chamber 80 for holding objects, and shoulder straps 90 for converting the stuffed toy 10 into a backpack.

The stuffed toy 10 is configured for use with a child car seat 14 that is positioned atop a seat 8 of a vehicle (e.g. a car or truck) having a shoulder belt 12 type seat belt. The stuffed toy 10 includes a body portion 20 that, preferably, is constructed or substantially filled with padded material. A head portion 22 is situated atop an upper end 26 of the body portion 20 and includes ornaments 24 (e.g. eyes, nose, mouth, or the like) indicative of an animal or other toy character. In other words, the stuffed toy may take the appearance of a stuffed teddy bear.

The body portion 20 includes a front side 30 and a rear side 32 and includes an exterior surface 34. A first end 42 of a first appendage 40 may be coupled to the exterior surface 34 of the front side 30 of the body portion, the first appendage 40 extending away from the body portion 20. Similarly, a first end of a second appendage 50 may be coupled to the exterior surface of the front side 30 of the body portion, the second appendage 50 extending away from the body portion 20. The second appendage 50 may be spaced apart from the first appendage 40 although both appendages are preferably adjacent the upper end 26 of the body portion 20 and are indicative of the arms of an animal or character being simulated by the stuffed toy 10. It is understood that the appendages are flexibly connected to the exterior surface 34 of the body portion 20 so as to move up and down or side to side in the manner of a teddy bear. In addition, the body portion 20 may include additional appendages indicative of legs of a stuffed animal or other toy character.

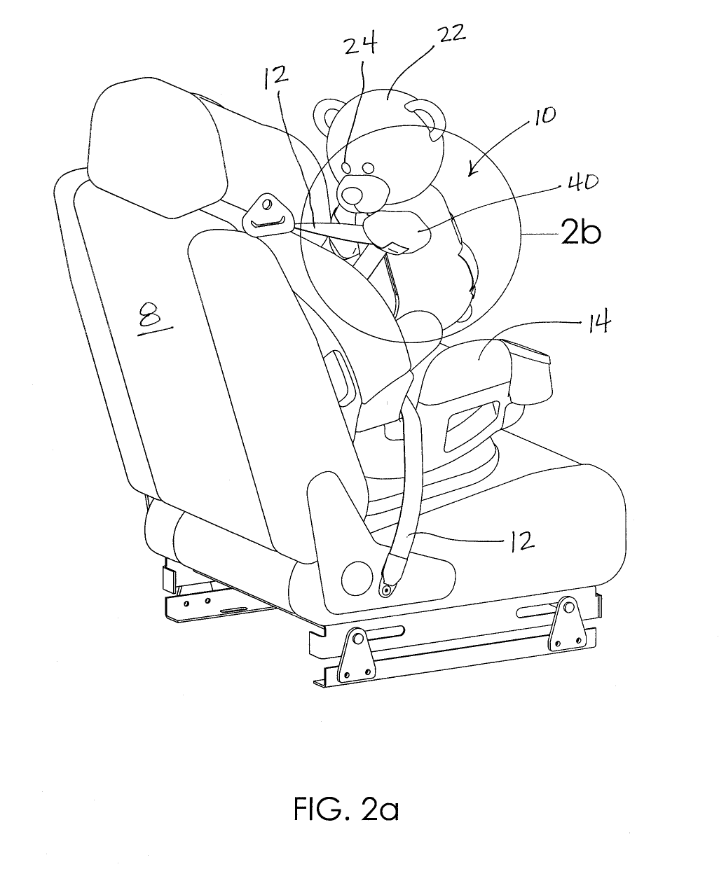

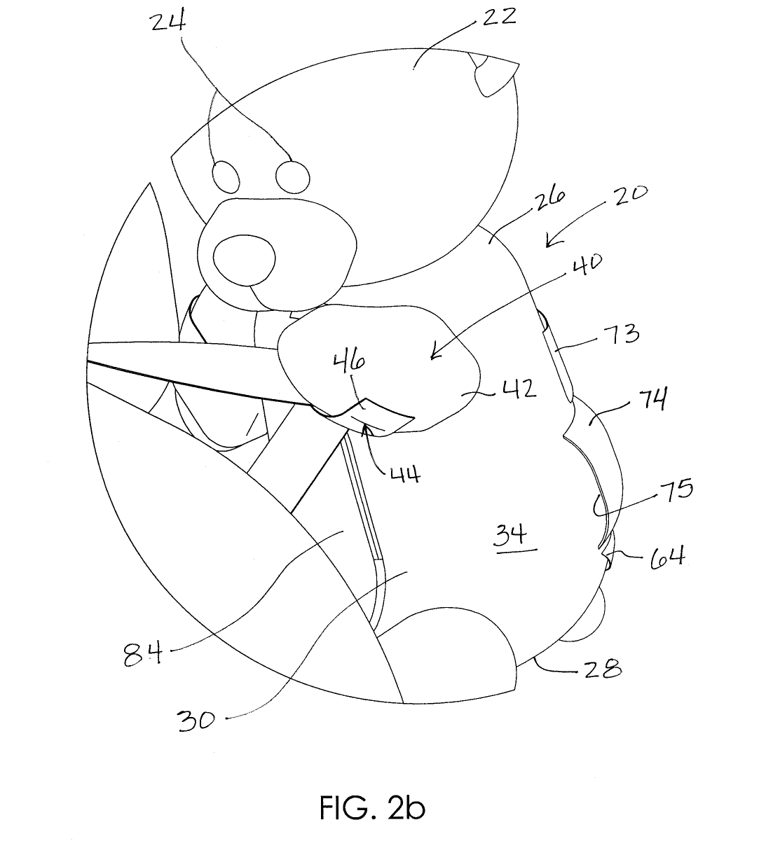

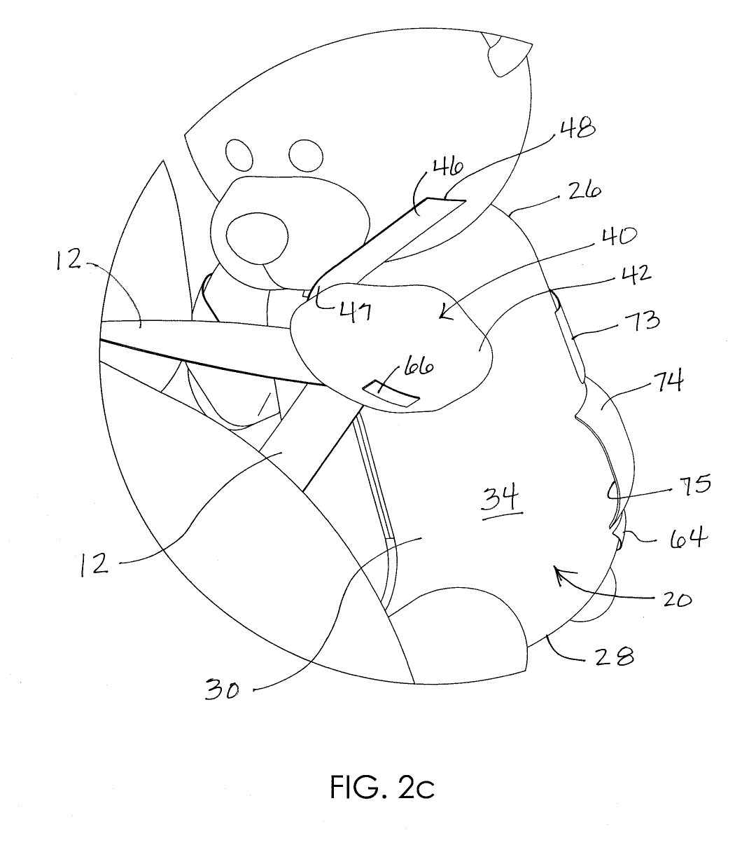

A first fastener 44 is coupled to the first appendage 40 and extends away therefrom. More particularly, the first fastener 44 includes a first strap 46 having a first end 47 fixedly attached to the first appendage 40 and a second free end 48 opposite the first end 47, the second free end 48 including one of a hook and loop material. Correspondingly, the first fastener 44 includes a first closure member 49 attached to the first appendage 40 at a location displaced from the first end 47 of the strap 46, the first closure member 49 having another of a hook and loop material. It is understood, therefore, that the first closure member 49 is complementary to the second free end 48 of the first strap 46 so as to be selectively coupled to or released therefrom. The first strap 46 is movable between a secured configuration in which the first strap 46 is tightly adjacent the first appendage 40 when the second free end 48 of the first strap 46 is coupled to the first closure member 49 (FIG. 2b) and a released configuration in which the first strap 46 is displaced from the first appendage 40 when the second free end 48 is not coupled to the first closure member 49 (FIG. 2c).

Similarly, a second fastener 52 includes a second strap 54 having a configuration substantially similar to the configuration of the first strap 46 described above although not shown in detail in the figures. For instance, the second strap 54 includes a first end fixedly attached to the second appendage and a second free end opposite the first end, the second free end including one of a hook and loop material. Correspondingly, the second fastener includes a second closure member attached to the second appendage 50 at a location displaced from the second end of the second strap 54, the second closure member having another of a hook and loop material. It is understood, therefore, that the second closure member is complementary to the second free end of the second strap 54 so as to be selectively coupled to or released therefrom. The second fastener is movable between a secured configuration in which the second strap 54 is tightly adjacent the second appendage 50 when the second free end of the second strap is coupled to the second closure member (FIG. 2b) and a released configuration in which the second strap 54 is displaced from the second appendage 50 when the second free end is not coupled to the second closure member (FIG. 2c).

The first fastener 44 is configured to receive the shoulder belt 12 of the vehicle at the secured configuration so as to secure the body portion 20 of the stuffed toy 10 to the shoulder belt 12. More particularly, the shoulder belt 12 may be received between the first strap 46 and the first appendage 40 when the first fastener 44 is at the released configuration (i.e. when the first strap 46 is released from the first closure member 49 (FIG. 2c). Then, the shoulder belt 12 may be secured to the first appendage 40 when the first end 47 of the first strap 46 is releasably and selectively coupled to first closure member 49 (FIG. 2b) as described above. It is understood that the second fastener 52 is selectively operable in like manner if a car seat is situated atop a vehicle seat from an opposed side of the vehicle and the opposite shoulder belt 12 is utilized.

When the shoulder belt 12 is received appropriately by the first fastener 44, the stuffed toy 10 is positioned forwardly of a child seated in the car seat 14 (FIG. 1). More particularly, the head portion 22 may be oriented to face the child and the first appendage 40 and second appendage 50 (i.e. the arms) may be viewed as essentially hugging the child.

It is understood fasteners other than hook and loop combinations may also be utilized in securing the first fastener 44 between secured and released configurations, such as clasps, snaps, buttons, D-rings, magnets, or the like.

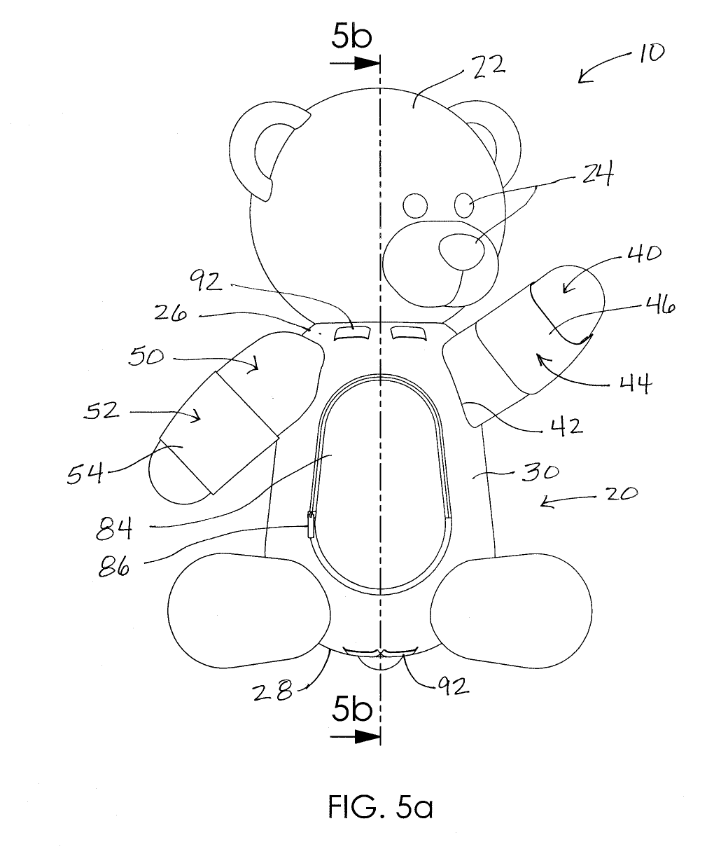

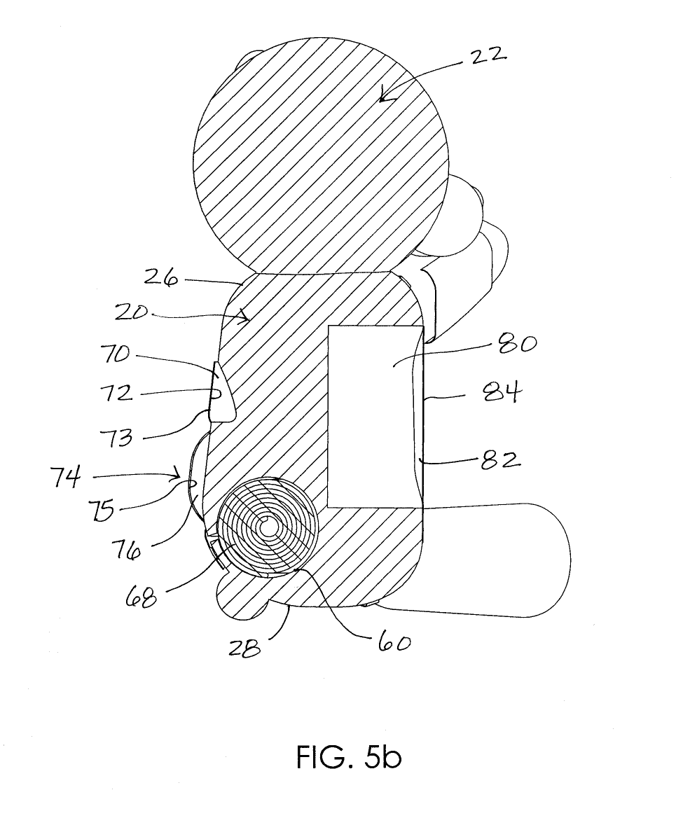

In an embodiment, the stuffed toy 10 includes a blanket 68. The body portion 20 defines a first chamber 60 having a configuration having a dimension to receive and store the blanket 68 (FIG. 5b). The rear side 32 of the body portion 20 may define a first chamber opening 62 that is configured to provide access to the first chamber 60. Specifically, the blanket 68 may be rolled up and inserted through the first chamber opening 62 for storage and transport in the first chamber 60. The blanket 68 may be selectively removed through the first chamber opening 62 as well. In an embodiment (not shown), the first chamber opening 62 may be defined by a front side 30 of the body portion 20, some other location.

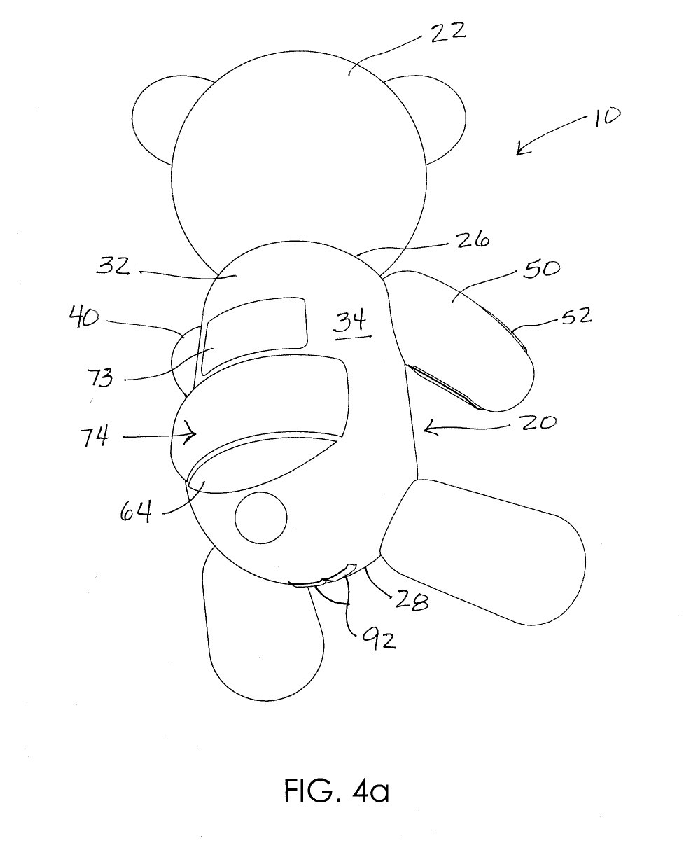

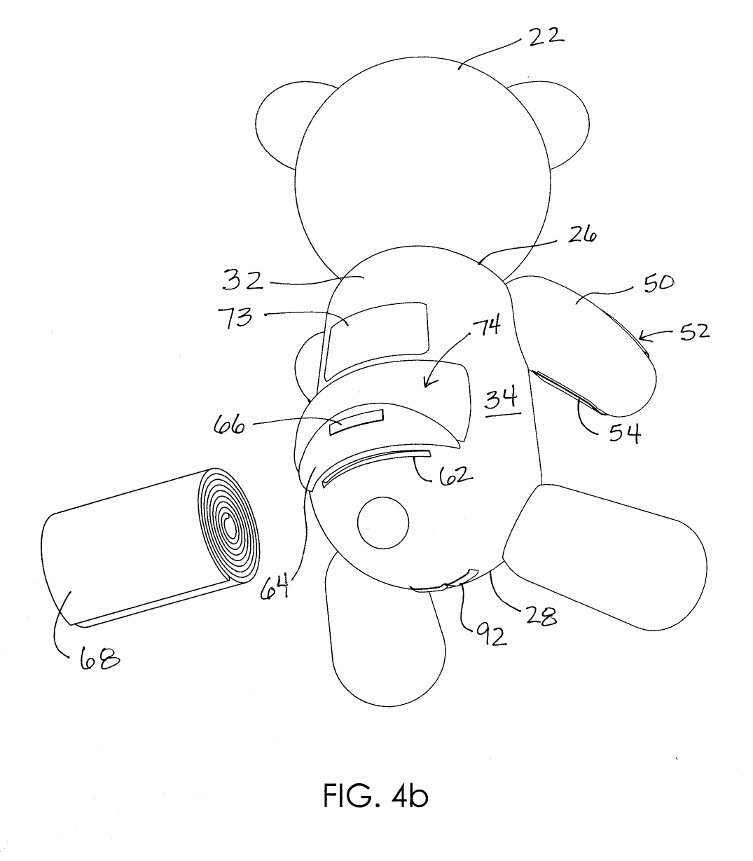

In an embodiment, a first chamber opening cover 64 may be mounted upwardly adjacent the first chamber opening 62, the first chamber opening cover 64 having a flexible configuration selectively movable between an extended configuration blocking access to the first chamber opening 62 (FIG. 4a) and a retracted configuration revealing and providing access to the first chamber opening 62 (FIG. 4b). More particularly, the first chamber opening cover 64 may be constructed of a material that is releasably coupled to a cover closure member 66 positioned below the first chamber opening 62 so that the chamber cover 64 is normally held in the extended configuration until specifically moved by a user to the retracted configuration such as when it is desired to insert or remove the blanket 68. Alternatively, the cover closure member 66 may be situated on an inner surface of the first chamber cover 64 itself (FIG. 4b).

In an embodiment, the body portion 20 defines a second chamber 70 separate from the first chamber 60 such as by an internal wall or padding material (FIG. 5b). Further, the rear side 32 of the body portion 20 may define a second chamber opening 72 and may also include a panel or cover 73 for regulating access to the second chamber 70. The second chamber 70 may also be referred to as a snack pocket as it includes dimensions appropriate for receiving one or more small food items appropriate for a toddler for whom the stuffed toy 10 is used as will be described later.

The stuffed toy 10 includes a hand warmer pocket 74 coupled to a rear side 32 of the body portion 20. The hand warmer pocket 74 may define opposed open ends 75 through which a user may insert respective hands into a singular interior space 76. It is important that the hand warmer pocket 74 be situated on the rear side 32 of the body portion 20 so that a child can reach around the body portion 20 in the manner of hugging a teddy bear when the body portion 20 is facing the child and when its appendages are coupled to the shoulder belt 12 as described above.

Further, the body portion 20 may define a main chamber 80 separate from the other chambers described above. The front side 30 of the body portion 20 may define a main chamber opening 82 in communication with the main chamber 80. Further, a main chamber panel 84 or cover may be attached to the front 30 and is movable between an open configuration allowing access into the main chamber 80 and a closed configuration blocking access to the main chamber 80. The main chamber panel 84 may include a zipper 86 or other suitable fastener coupled to the front side 30 configured to allow incremental movement between open and closed configurations. Preferably, the main chamber 80 is dimensionally larger than the other chambers for receiving multiple articles when the stuffed toy 10 is configured as a backpack as will be described below. It is understood that the main chamber 80, in one embodiment (not shown), may be accessed from a wall other than the front side 30.

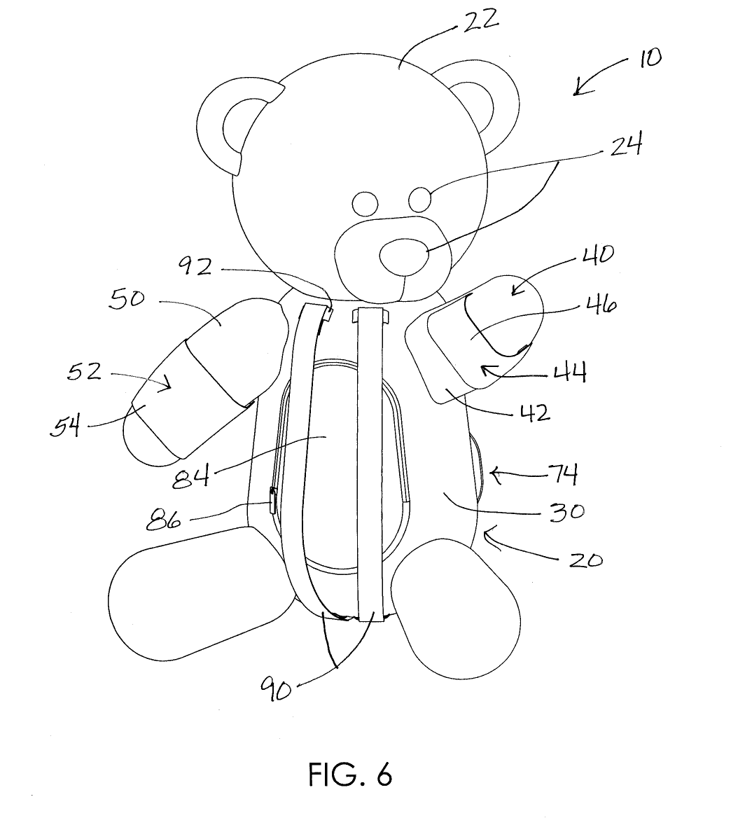

A pair of backpack shoulder straps 90 is removably coupled to the front side 30 of the body portion 20 so that the stuffed toy 10 may be selectively converted to a backpack (FIG. 6). The shoulder straps 90 may be spaced apart, positioned between the first 40 and second 50 appendages, and situated parallel to one another and positioned adjacent the main chamber 80 and main chamber panel 84. Each shoulder strap 90 includes opposed upper and lower ends that extend substantially between upper 26 and lower 28 ends of the body portion 20. The respective ends of the shoulder straps are coupled to the body portion 20 using fasteners that include hook and loop fastener combinations. In addition, ends of the straps 90 may be threaded about respective loop fasteners 92 coupled to the exterior surface 34 of the body portion 20 adjacent upper 26 and lower 28 ends thereof as shown. Other fasteners, of course, may be used for shoulder strap 90 attachments, such as snaps, clasps, magnets, wires, friction fit structures, clips, threaded fasteners, or the like. When not desired to be worn as a backpack, the shoulder straps 90 may be removed and stored in the main chamber 80.

As indicated above, the head portion 22 may be constructed of a padded material and be situated atop the body portion 20 to contribute to the appearance of an animal or other character and also to provide padding to a child occupant of the car seat 14. It is anticipated that when the stuffed toy 10 is positioned in front of a child (when coupled to a shoulder belt 12), the head portion 22 may be embraced by the child and positioned to the side of the child's head. This positioning will allow a child to sleep in the car seat while maintaining his own head in a comfortable position rather than oscillating side to side.

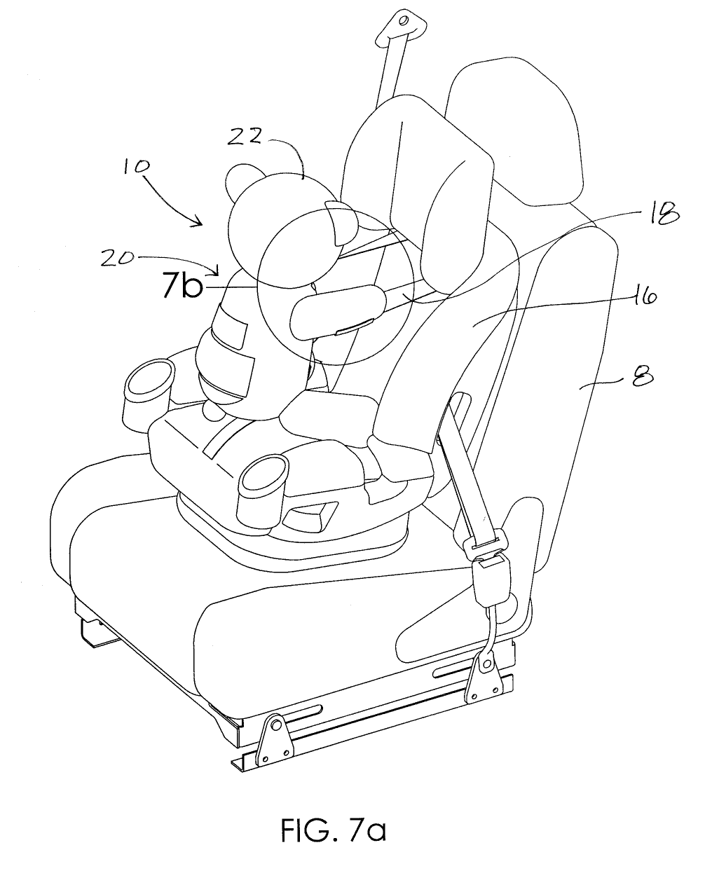

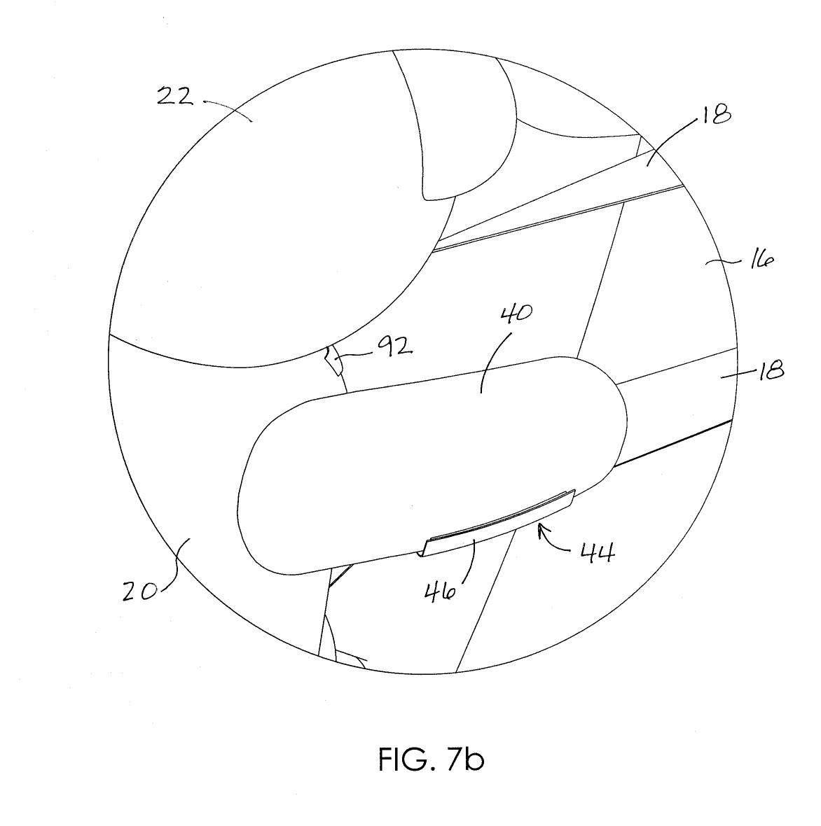

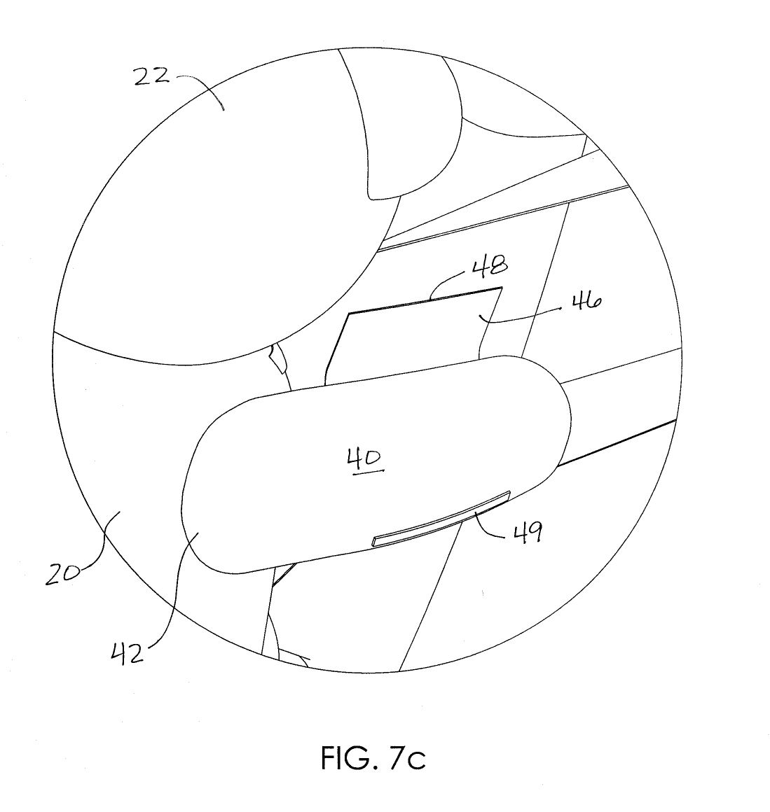

It is recognized that some child car seats include their own safety belts 18 that extend over the shoulders and heads of an infant or toddler and are coupled to the car seat 16 adjacent a child's crotch. The present invention is effective at being coupled to the safety belts 18 of this type of car seat 16 as shown in FIGS. 7a and 7b. More particularly, the first fastener 44 is configured to receive a respective safety belt 18 of the over-the-shoulder car seat 16 when in the released configuration and then to secure the safety belt 18 against the first appendage 40 at the secured configuration as described above relative to a shoulder belt 12 of the vehicle. The second fastener operates in like manner. In this manner, the stuffed toy 10 is positioned forwardly of a child seated in the car seat and, more particularly, is positioned facing the face of the child. The first 40 and second 50 appendages may even rest atop the shoulders of the child as if hugging him.

In use, the stuffed toy 10 of the present invention can be used with a child car seat 14 in order to provide a head support to a child seated in the car seat 14 while also storing important articles in various compartments. As described above, the first fastener 44 of the first appendage 40 of the body portion 20 of the stuffed toy 10 is configured to receive a shoulder belt 12 of a vehicle and to secure it to the first appendage 40 in a manner that positions the stuffed toy 10 frontwardly adjacent a child seated in the car seat. Similarly, the first fastener 44 is configured to receive a safety belt of an over-the-head type child car seat 16. The body portion 20 defines a first chamber 60 configured to selectively store a blanket 68, a second chamber 70 configured to store articles such as food items, and a main chamber 80 configured to hold articles in the manner of a backpack. In addition, a pair of backpack straps 90 are removably coupled to a front side 30 of the body portion 20 so that the body portion 20 may be worn as a backpack when not coupled to a shoulder belt 12 or safety belt 18.

It is understood that while certain forms of this invention have been illustrated and described, it is not limited thereto except insofar as such limitations are included in the following claims and allowable functional equivalents thereof.

1. A stuffed toy for use with a child car seat that is positioned in an automobile having a shoulder safety belt, said stuffed toy comprising:
a body portion containing a padded material;
a first appendage coupled to and extending away from an exterior surface of said padded body portion;
a first fastener coupled to said first appendage that is movable between a secured configuration tightly adjacent said first appendage and a released configuration displaced from said first appendage;
wherein said first fastener is configured to selectively receive the shoulder safety belt and is coupled thereto when said first fastener is in said secured configuration so as to position said body portion frontwardly adjacent the child car seat.

2. The stuffed toy as in claim 1, comprising:
a second appendage coupled to and extending away from said exterior surface of said padded body portion, said second appendage spaced apart from said first appendage; and
a second fastener coupled to said second appendage that is movable between a secured configuration tightly adjacent said second appendage and a released configuration displaced from said second appendage;
wherein said second fastener is configured to selectively receive the shoulder safety belt and is coupled thereto when said second fastener is in said secured configuration so as to position said body portion adjacent the child car seat.

3. The stuffed toy as in claim 1, wherein:
said body portion defines a first chamber; and
said body portion includes a front wall and a rear wall opposed from said front wall, said rear wall defining a first chamber opening in communication with said first chamber.

4. The stuffed toy as in claim 3, comprising a blanket selectively positioned in said first chamber via said first chamber opening.

5. The stuffed toy as in claim 3, wherein:
said body portion defines a second chamber separated from said first chamber; and
said rear wall of said body portion defines a second chamber opening in communication with said second chamber, said second chamber opening configured to receive an object into or out of said second chamber.

6. The stuffed toy as in claim 3, wherein:
said body portion defines a main chamber separated from said first chamber;
said front wall of said body portions defines a main chamber opening in communication with said main chamber;
said stuffed toy includes a main chamber panel coupled to said front wall and selectively movable between an open configuration allowing access to said main chamber via said main chamber opening and a closed configuration blocking access to said main chamber via said main chamber opening.

7. The stuffed toy as in claim 6, comprising a hand warmer pocket situated on said rear wall of said body portion, said hand warmer pocket defining opposed openings configured to provide access to an interior space.

8. The stuffed toy as in claim 3, comprising a hand warmer pocket situated on one of said front wall or said rear wall of said body portion, said hand warmer pocket defining opposed openings configured to provide access to an interior space.

9. The stuffed toy as in claim 6, wherein said main chamber panel is coupled to said front wall with a zipper that is configured to move incrementally between open and closed positions.

10. The stuffed toy as in claim 1, wherein:
said first fastener includes a first strap member having a first end fixedly attached to said first appendage adjacent said body portion and a second free end having one of a hook or loop material;
said first fastener includes a first closure member attached to said first appendage at a position displaced from said first end of said first fastener, said first closure member having another of a hook and loop material; and
said second free end of said strap member is releasably coupled to said first closure member at said secured configuration.

11. The stuffed toy as in claim 10, wherein:
said second fastener includes a second strap member having a first end fixedly attached to said second appendage adjacent said body portion and a second free end having one of a hook and loop material;
said second fastener includes a second closure member attached to said second appendage at a position displaced from said first end of said second fastener, said second closure member having another of a hook and loop material; and
said second free end of said second strap member is releasably coupled to said second closure member at said secured configuration.

12. The stuffed toy as in claim 1, comprising a first cover member coupled to said rear wall of said body portion upwardly adjacent said first chamber opening, said first cover member normally covering said first chamber opening.

13. The stuffed toy as in claim 12, wherein said first cover member includes a cover member fastener configured to releasably hold said first cover member in a position obstructing said first chamber opening.

14. The stuffed toy as in claim 6, further comprising a pair of shoulder straps releasably coupled to said front side of said body portion proximate said main chamber panel, said pair of shoulder straps being spaced apart and generally parallel to one another and extending substantially between upper and lower ends of said body portion.

15. The stuffed toy as in claim 14, wherein said pair of shoulder straps include upper and lower ends, respectively, that are releasably coupled to said front side of said body with a combination of hook and loop fasteners.

16. The stuffed toy as in claim 2, comprising a pair of shoulder straps releasably coupled to said front side of said body portion, said pair of shoulder straps being spaced apart between said first appendage and said second appendage and generally parallel to one another and extending substantially between upper and lower ends of said body portion.

17. The stuffed toy as in claim 1, further comprising a head portion situated atop said body portion, said head portion having a padded construction for selectively supporting the head of a child seated in the car seat.

18. The stuffed toy as in claim 2, wherein:
said first fastener is configured to receive a safety belt of the car seat and is selectively coupled thereto when said first fastener is in said secured configuration so as to position said body portion frontwardly adjacent the child car seat; and
said second fastener is configured to receive the safety belt of the car seat and is selectively coupled thereto when said second fastener is in said secured configuration so as to position said body portion frontwardly adjacent the child car seat.

19. The stuffed toy as in claim 6, wherein:
said first fastener is configured to receive a safety belt of the car seat and is selectively coupled thereto when said first fastener is in said secured configuration so as to position said body portion frontwardly adjacent the child car seat; and
said second fastener is configured to receive the safety belt of the car seat and is selectively coupled thereto when said second fastener is in said secured configuration so as to position said body portion frontwardly adjacent the child car seat.

20. The stuffed toy as in claim 17, wherein:
said head portion includes a front side having ornaments indicative of facial features of an animal.
